(19) United States
(12) Patent Application Publication
(10) Pub. No.: US 2024/0128574 A1
(43) Pub. Date: Apr. 18, 2024

(54) MANUFACTURE OF COMPONENTS FOR BATTERIES

(71) Applicant: JAGUAR LAND ROVER LIMITED, Whitley, Coventry, Warwickshire (GB)

(72) Inventors: Connor LAVENDER-MOORE, Wolverhampton, West Midlands (GB); Steve JONES, Warwick, Warwickshire (GB); Debora MAZZETTA, Coventry, Warwickshire (GB); James THRIPPLETON, Stratford Upon Avon, Warwickshire (GB)

(21) Appl. No.: 18/277,057

(22) PCT Filed: Feb. 14, 2022
(86) PCT No.: PCT/EP2022/053479

§ 371 Date: Aug. 11, 2023

(30) Foreign Application Priority Data
Feb. 12, 2021 (GB) 2101960.9

(51) Int. Cl. H01M 50/26; H01M 50/213; H01M 50/249; H01M 50/507

(52) U.S. Cl. CPC H01M 50/26; H01M 50/213; H01M 50/249; H01M 50/507; H01M 2220/20

(57) ABSTRACT

The present invention provides a method of producing a set of mechanically connected cells (200), especially for use in a vehicle traction battery (704). The method comprises placing successive layers of cells into a fixture, and joining each new layer to the existing layers using a layer of adhesive.

### TECHNICAL FIELD

The present invention relates generally to manufacture of components for batteries. In particular, but not exclusively, the invention relates to manufacture of sets of mechanically connected cells for vehicle traction batteries. Aspects of the invention relate to a method of manufacture of a set of mechanically connected cylindrical cells battery module, to a method of manufacture of a battery, to a battery module, to a battery pack, and to a vehicle.

### BACKGROUND

There has recently been increased interest in providing battery-powered vehicles, which has led to developments in vehicle battery, in particular vehicle traction battery, technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module as densely as can safely be achieved, so as to maximise the energy and current capacity that can be provided within a given packaging volume.

In the manufacture of vehicle battery modules, it is important to ensure that all of the individual components of the module can be reliably made to the required dimensional tolerances.

It is an object of embodiments of the invention to at least mitigate one or more of the problems of the prior art.

### SUMMARY OF THE INVENTION

According to an aspect of the invention for which protection is sought, there is provided a method of manufacture of a set of mechanically connected cylindrical cells, the method comprising:
providing a fixture having a base having a plurality of location features defined therein, wherein:
   each of the location features is arranged to constrain a cylindrical cell placed therein such that the longitudinal axes of the cells in the location features are substantially parallel;
   a first group of the location features are arranged to constrain a cell placed in the respective location feature such that the longitudinal axis of each cell is located in a first plane;
   a second group of location features are arranged to constrain a cell placed in the respective location feature such that the longitudinal axis of each cell is located in a second plane parallel to the first plane; and
   each of the location features in the second group is adjacent to one or two location features in the first group, and is not adjacent to any location features in the second group,
placing one of a first group of cylindrical cells into each of the location features in the first group of location features and placing one of a second group of cylindrical cells into each of the location features in the second group of location features;
applying a layer of adhesive over the upper surface of the cylindrical cells in the fixture;
placing one of a third group of cylindrical cells on top of each of the cells in the first group of cylindrical cells;

applying a layer of adhesive over the upper surface of the cylindrical cells in the fixture; and

placing one of a fourth group of cylindrical cells on top of each of the cells in the second group of cylindrical cells.

Advantageously, such a method may help to at least mitigate the effects of tolerance stack on the overall dimensions of the group of cells.

It will be understood that those skilled in the art may also refer to a “fixture” as a “jig”.

In an embodiment, the fixture further comprises first and second side walls upstanding from the base, and wherein the first and second side walls are arranged to constrain the position of one or more of the cells in the third and/or fourth groups.

In an embodiment, the adjacent cell location features are spaced apart by a distance of less than the diameter of the cells, plus 1 mm. The adjacent cell location features may be spaced apart by a distance of less than the diameter of the cells, plus 0.5 mm. In some embodiments, the adjacent cell location features are spaced apart by a distance of less than the diameter of the cells, plus 5%, optionally plus 2%. Advantageously, such spacing ensures that the adhesive can effectively join the adjacent cells.

In an embodiment, each of the first, second, third and fourth groups of cells comprises two or three cells.

The method may further comprise:
after placing the fourth group of cylindrical cells, applying a layer of adhesive over the upper surface of the cylindrical cells in the fixture; and
placing one of a fifth group of cylindrical cells on top of each of the cells in the third group of cylindrical cells.

In an embodiment, the method further comprises:
after placing the fifth group of cylindrical cells, applying a layer of adhesive over the upper surface of the cylindrical cells in the fixture; and
placing one of a sixth group of cylindrical cells on top of each of the cells in the fourth group of cylindrical cells. It will be understood that the number of groups of cells required will depend on the desired size of the finished group of cells.

In an embodiment, the method further comprises:

after placing the fifth group of cylindrical cells, placing one of a sixth group of cylindrical cells on top of each of the cells in the fourth group of cylindrical cells. It will be understood that in an embodiment in which a total of six groups of cells are required, it is preferable not to apply a layer of adhesive on top of the fifth group of cells. This allows a top part of the fixture to be placed over the completed group of cells, without the top part sticking to the cells.

According to another aspect of the invention for which protection is sought, there is provided a method of manufacture of a battery module comprising:

manufacturing first and second sets of mechanically connected cylindrical cells, wherein each sets of mechanically connected cylindrical cells is manufactured according to a method as claimed in any preceding claim;
connecting a respective busbar assembly to each of the first and second sets of mechanically connected cylindrical cells, wherein the busbar assemblies are located proximate the first ends of the cells in the respective set and are arranged to electrically connect the plurality of cells in each set in parallel, thereby to create first and second sub-assemblies; positioning the first and second sub-assemblies within a housing; and
electrically connecting the busbar assemblies of the first and second sub-assemblies, such that the cells in the first sub-assembly are electrically connected to the cells in the second sub-assembly in series.

According to another aspect of the invention for which protection is sought, there is provided a method of manufacture of a vehicle, comprising manufacturing a battery module according to a method as described above or a set of mechanically connected cylindrical cells according to a method as described above, and further comprising installing the battery module or the set of mechanically connected cylindrical cells within the vehicle.

According to another aspect of the invention for which protection is sought, there is provided a battery module manufactured according to the method of any preceding claim.

According to another aspect of the invention for which protection is sought, there is provided a vehicle comprising a battery module as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIGS. 1A-C show different views of a cylindrical cell that may be used in a vehicle battery module (PRIOR ART);

FIG. 2 shows a group of cylindrical cells mechanically bonded together according to an embodiment of the present invention;

FIG. 3 shows a fixture in which a group of mechanically bonded cylindrical cells can be produced in an embodiment of the present invention;

FIGS. 4A-D show different stages of a method of manufacture of a group of mechanically bonded cylindrical cells in an embodiment of the present invention;

FIG. 5A shows an enlarged cross-sectional view of the cells during manufacture of a group of mechanically bonded cells in an embodiment of the present invention;

FIG. 5B shows an image of an adhesive path for use in a method of mechanically joining a group of cylindrical cells in an embodiment of the present invention;

FIG. 6 shows a flow chart illustrating the steps in a method of manufacture of a set of mechanically connected cylindrical cells and subsequent assembly into a battery module in an embodiment of the present invention; and

FIG. 7 shows a vehicle in an embodiment of the present invention.

### DETAILED DESCRIPTION

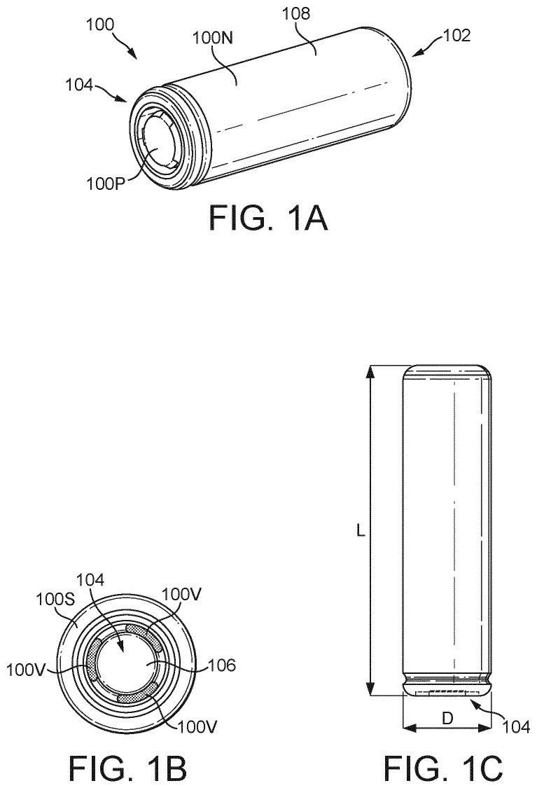

FIGS. 1A-C show different views of a conventional cylindrical cell 100. Cylindrical cells 100 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood by the skilled person, the cell 100 comprises a positive terminal 100P, a negative terminal 100N, and vent means 100V. The positive terminal is provided by a steel end cap 106 in a central region of the first end 104 of the cell, and the negative terminal is provided by a steel cylindrical case 108. The steel cylindrical case 108 covers the second end 102, the entire cylindrical surface between the first and second ends, and a peripheral region 100S of the first end surface. The peripheral region of the first end surface may also be referred to as a “shoulder” region 100S of the first end surface 104. In commercially-available cells, the end cap that defines the positive terminal 100P on the first end surface 104 sometimes protrudes beyond the shoulder region 100S of the first end surface, although this is not the case in the cell shown in FIG. 1. The positive terminal protruding beyond the shoulder region 100S allows a substantially planar connector to be connected to the positive terminal and not the negative terminal. As will be well understood by the skilled person, it is important to avoid direct electrical connections between the positive and negative terminals, as such connections create a short circuit which may damage the cell.

As shown in FIG. 1, the cell 100 comprises three vent means 100V in the first end surface 104, between the steel end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell, thereby mitigate against the risk of the cell exploding.

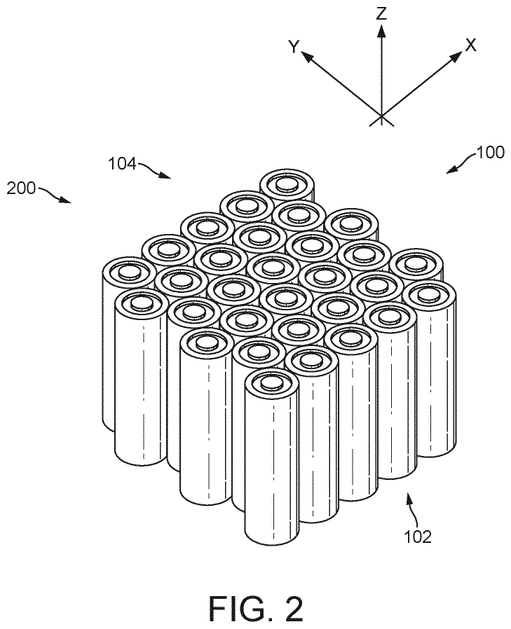

FIG. 2 shows a block 200 comprising a plurality of cylindrical cells 100 mechanically joined together via an adhesive on the cylindrical surfaces of the cells 100. At its narrowest point, the adhesive has a thickness of 0-0.5 mm, preferably 0.2-0.4 mm. It will be understood that the diameter of the cells is not controlled to a very high dimensional tolerance. Accordingly, the 40 thickness of the layer of adhesive between adjacent cells may vary depending upon the actual dimensions of the cells, and this variation may help to mitigate the effects of the dimensional tolerance of the cells 100 on the overall dimensional tolerance of the block 200.

The block 200 shown in FIG. 2 comprises 30 cylindrical cells arranged in a common orientation and in a side-to-side configuration. The block comprises six rows of five cells, each row being offset from the adjacent rows by a distance approximately equal to the radius of one of the cylindrical cells, thereby improving the efficiency with which the cells can be packaged into a given volume. It will be understood that other configurations of the block 200 are also useful, and that the block may comprise more or fewer cells in different embodiments.

The adhesive layer between the cells 100 in the block 200 has a relatively high electrical resistance. As such, whilst the cells 100 in the block 200 are mechanically joined together, the cylindrical surfaces (which form part of the negative terminal of the cells) are not likely to be electrically connected to one another. However, as will be explained in more detail below, when the blocks 200 are assembled to form part of a battery module, the cells within each block will all be electrically connected together in parallel. Accordingly, it is perfectly acceptable for electrical connections to be present between the cylindrical surfaces of some or all of the cells within the block 200.

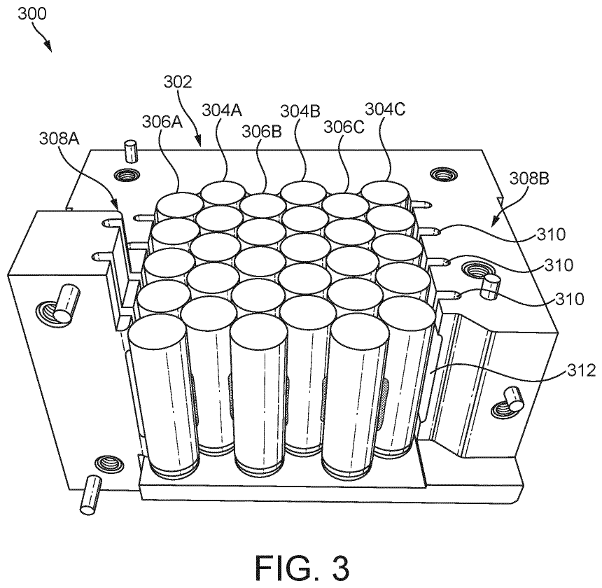

FIG. 3 shows a fixture, or jig, 300 in which a group of mechanically-connected cells 200 may be manufactured according to an embodiment of the present invention. The fixture 300 comprises a base 302 having a first group of location features 304A-C and second group of location features 306A-C defined therein. As shown in FIG. 3, each of the location features 304A-C in the first group is arranged to constrain a cylindrical cell such that its longitudinal axis is substantially parallel and lies within a common plane with the longitudinal axes of the cells in the other two location features in the first group. The common plane in which the cells in the first group of location features 304A-C lie may be referred to as a first plane.

Similarly, each of the location features 306A-C in the second group is arranged to constrain a cell placed therein to be substantially parallel and coplanar with the cells in the other two location features in the second group. The common plane in which the cells in the second group of location features 306A-C lie may be referred to as a second plane, and is parallel to the first plane.

The fixture 300 also comprises first and second side walls 308A, 308B upstanding from the base 302. It will be noted that the side walls are provided with several recesses 310, 312. These recesses are placed at locations that do not interfere with the abutment of cells against the side walls. The recesses are provided to help to allow evaporated solvent from the adhesive used in mechanically joining the cells within the fixture 300 to escape.

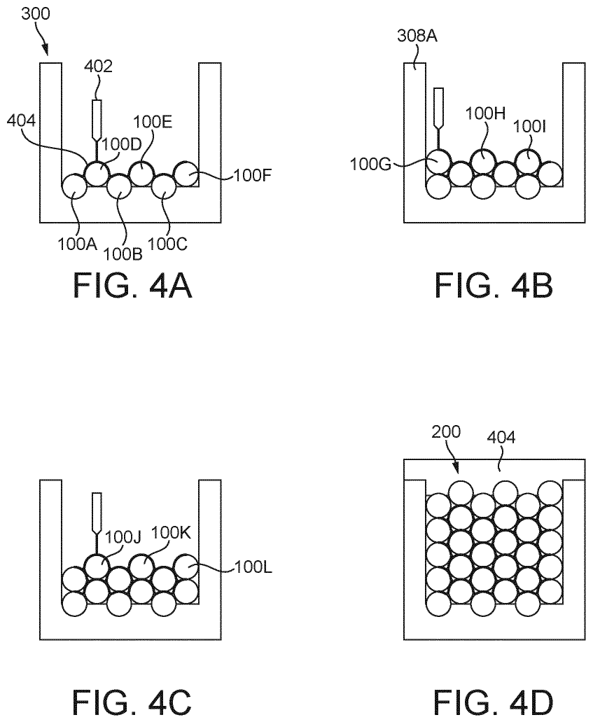

Once the cells are in position within the each of the location features in the first and second groups, subsequent cells may be placed within the fixture at well-defined positions by placing them on top of the cells that are already in place, because the newly-placed cells will abut a plurality of the existing cells and in some cases one of the side walls. A method of manufacture of a set of mechanically-connected cells by placing them in a fixture 300 in an embodiment of the present invention will be discussed below with respect to FIGS. 4-6.

FIG. 4A shows a cross-sectional view through a fixture 300 as shown in FIG. 3 during a first stage in the manufacture of a group of mechanically connected cells 200. As shown in FIG. 4A, cells 100A-C are located in the first group of location features 304A-C, and cells 100D-F are located in the second group of location features 306A-C. It will be understood that it is typically more convenient to place the cells 100A-C in the first group of location features 304A-C before placing the cells 100D-F into the second location features, because the cells in the first group of location features help to constrain the cells in the second group of location features. However, it would also be possible to first place the cells 100D-F into the second group of location features, and then to slide the cells 100A-C into the first group of location features in an axial direction.

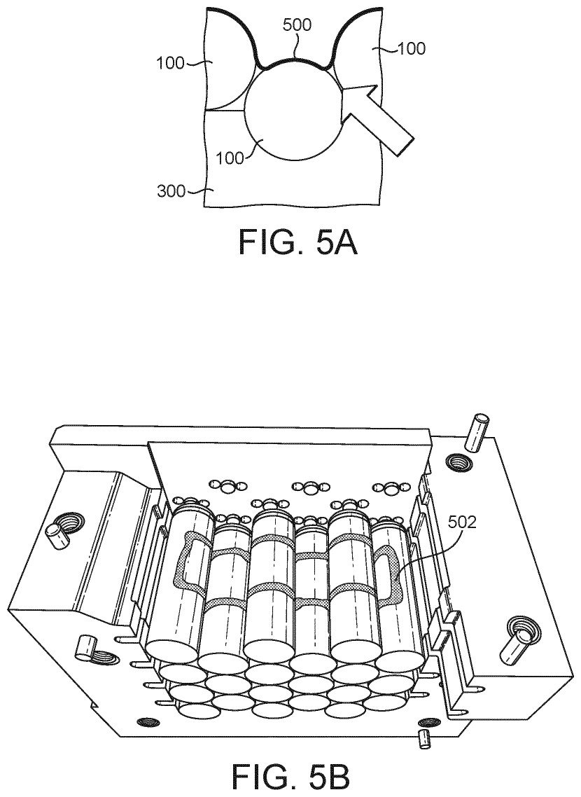

Once the cells 100A-F are in place within the respective location features, a layer of adhesive is applied over the cells. It will be understood that the term “layer” is not intended to, and does not, imply that the adhesive is uniformly applied over the cells. In the illustrated embodiment, an elongate bead of adhesive is applied in a predetermined shape by a robot-controlled applicator 402. However, in other embodiments, the adhesive may be applied manually. The bead of adhesive may have any suitable shape, as will be discussed in more detail below with respect to FIGS. 5A and 5B.

After the layer of adhesive had been applied on top of the cells 100A-F, three additional cells 100G-1 are placed into fixture 300, directly above the cells 100A-C in the first location features. Cells 100H and 1001 are held in place by the cells that are already in the fixture 300, whereas cell 100G is partially supported by the other cells and partially supported by the side wall 308A. After the cells 100G-1 are in their respective positions in the fixture 300, the applicator 402 applies another layer of adhesive on top of the cells in the fixture. As shown in FIG. 4C, three further cells 100J-L are then positioned in the fixture 300 on top of the cells 100D-F. As shown in FIG. 4C, cells 100J and 100K are supported by the cells that are already in place within the fixture 300, whereas cell 100L is partially supported by the existing cells, and partially by the side wall 308B.

Once the cells 100J-L are in place within the fixture 300, a further layer of adhesive is applied on top of the cells in the fixture by the applicator 402. The manufacture of the group of mechanically connected cells 200 then continues in a similar manner, with a further three cells being positioned in the lowest available positions within the fixture 300 and further layers of adhesive being placed over the new cells, until there is only room for two more sets of three cells within the fixture. The penultimate and final sets of three cells are positioned in the fixture in the same way as the preceding groups of cells, but no layer of adhesive is applied on top of these sets of cells. After the final cells are put in place, a lid 404 is applied on top of the fixture 300 to hold the cells in place, and the adhesive is allowed to cure. It will be understood that not providing adhesive on the last two sets of cells prevents the lid 404 from sticking to the group of mechanically connected cells 200. The lid 404 of the embodiment of FIG. 4D is configured to apply a compressive force to the penultimate and final sets of cells and thereby to the entire group of cells 200 in order to ensure all cells are in contact with adhesive and provide a final condition of the block of cells 200 that is within dimensional limits. In other embodiments the lid 404 comprises resilient elements in contact with the penultimate and final layers of cell for accommodating the lid 404 to any unevenness in the cells. This embodiment does not control the dimensional tolerance so accurately. Optionally this lid 404 is absent and the final dimension is allowed to depend on the effect of gravity acting on the cells and adhesive. In some embodiments the adhesive is cured by the application of light, such as ultra-violet light, which therefore allows the above assembly method to be carried out with the adhesive at a constant degree of viscosity before curing.

FIG. 5A shows an elongate bead of adhesive 500 on top of three cells 100 within the fixture 300. When placing the bead of adhesive 500, it is important that the speed of the applicator (or the speed of movement of the operator, in embodiments in which the adhesive is applied manually) is sufficiently low that the bead substantially follows the curvature of the cells when it traverses the gap between two adjacent cells. This helps to ensure the mechanical integrity of the group of mechanically connected cells 200.

FIG. 5B shows a layer of adhesive 502 comprising a single elongate bead of adhesive that forms a loop on top of the cells 100. Although the layers of adhesive may have substantially any shape, provided sufficient adhesive is applied to each of the cells, it will be understood that it is preferable for the layer to include two portions on each cell, and for the two portions to be spaced apart by at least 20% of the overall length of the cell, more preferably by at least 30% of the overall length of the cell. Spacing apart the separate portions of adhesive in this way helps to improve the stiffness and strength of the resulting group of cells 200, especially when it is bent about an axis perpendicular to longitudinal axes of the cells.

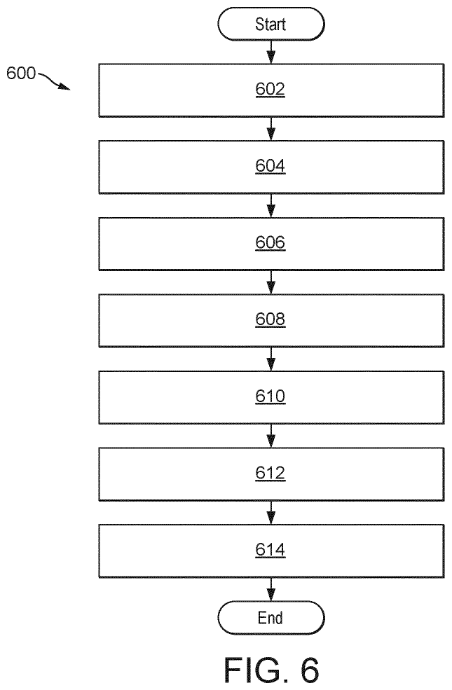

FIG. 6 is a flow chart illustrating a method 600 for manufacturing a group of mechanically-connected cells in an embodiment of the present invention. Descriptions of the steps of FIG. 6 are given in Table 1. Method 600 starts at step 602, in which a fixture having a base with a plurality of location features is provided. The method then proceeds to step 604, in which cell from a first group of cylindrical cells is placed into the each of the location features in the first group of location features. In the embodiment illustrated in FIGS. 3-5, the first group of location features consists of three location features. However, it will be understood that other numbers of location features in the first group are also useful.

The method then proceeds to step 606, in which one of a second group of cells is positioned into each of the second group of location features. Again, in the embodiment illustrated in FIGS. 3-5, there are three location features in the second group of location features. However, other numbers of location features are also useful.

Once the first and second groups of cells are in place, a layer of adhesive is applied on top of the first and second groups of cells, in step 608. As discussed in more detail above, the layer of adhesive need not be a planar layer, and in many embodiments it will not be. Instead, an elongate bead of adhesive may be applied. It is important that the adhesive follows the curvature of the cells, especially in the region where adjacent cells meet, to ensure that the cells are firmly joined together. The method then proceeds to step 610, in which a third group of cells are put in place on top of the first group of cells. An additional layer of adhesive is then applied on top of the third group of cells in step 612, and a fourth group of cells is then put in place on top of the second group of cells in step 614. At this stage, the method may end, or alternatively another layer of adhesive may be applied, and a further group of cells may be put in place on top of the third group of cells. In some embodiments, the method may continue in this way until the desired number of groups of cells are in place. Preferably, no layer of adhesive is applied before putting the final group of cells in place. This allows a cover for holding the cells in place to be placed on top of the fixture, without risking the adhesive sticking the cover to the cells.

TABLE 1
Method steps of FIG. 6

| Reference | |
|---|---|
| numeral | Description |
| 602 | Providing a fixture having a base having a plurality of location |
| | features defined therein |
| 604 | Place one of a first group of cylindrical cells into each of the |
| | location features in the first group of location features |
| 606 | Place one of a second group of cylindrical cells into each of |
| | the location features in the second group of location features |
| 608 | Apply a layer of adhesive over the upper surfaces of the cells |
| | in the fixture |
| 610 | Place one of a third group of cylindrical cells on top of each |
| | of cells in the first group of cells |
| 612 | Apply a layer of adhesive over the upper surfaces of the cells |
| | in the fixture |
| 614 | Place one of a fourth group of cylindrical cells on top of each |
| | of cells in the second group of cells |

Following the assembly process of FIG. 6 the adhesive may be cured by the application of light if the adhesive is a light-sensitive adhesive. Other types of curing adhesive are possible such as delay-curing adhesive.

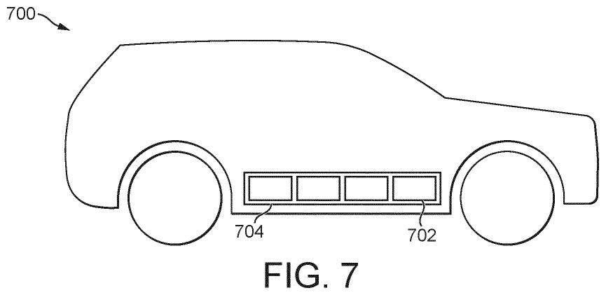

FIG. 7 shows a vehicle 700, into which a battery module 702 according to one or more embodiments of the present invention may be incorporated. In some embodiments, the vehicle may comprise a battery pack, or vehicle traction battery 704, including a plurality of battery modules according to embodiments of the present invention.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of manufacture of a set of mechanically connected cylindrical cells, the method comprising:
providing a fixture having a base having a plurality of location features defined therein, wherein:
each of the location features is arranged to constrain a cylindrical cell placed therein such that the longitudinal axes of the cells in the location features are substantially parallel;
a first group of the location features are arranged to constrain a cell placed in the respective location feature such that the longitudinal axis of each cell is located in a first plane;
a second group of location features are arranged to constrain a cell placed in the respective location feature such that the longitudinal axis of each cell is located in a second plane parallel to the first plane; and
each of the location features in the second group is adjacent to one or two location features in the first group, and is not adjacent to any location features in the second group,
placing one of a first group of cylindrical cells into each of the location features in the first group of location features and placing one of a second group of cylindrical cells into each of the location features in the second group of location features;
applying a layer of adhesive over the upper surface of the cylindrical cells in the fixture;
placing one of a third group of cylindrical cells on top of each of the cells in the first group of cylindrical cells;
applying a layer of adhesive over the upper surface of the cylindrical cells in the fixture; and
placing one of a fourth group of cylindrical cells on top of each of the cells in the second group of cylindrical cells.

2. The method as claimed in claim 1, wherein the fixture further comprises first and second side walls upstanding from the base, and wherein the first and second side walls are arranged to constrain the position of one or more of the cells in the third and/or fourth groups.

3. The method as claimed in claim 1, wherein the adjacent cell location features are spaced apart by a distance of less than the diameter of the cells, plus 1 mm.

4. The method as claimed in claim 3, wherein the adjacent cell location features are spaced apart by a distance of less than the diameter of the cells, plus 0.5 mm.

5. The method as claimed in claim 1, wherein each of the first, second, third and fourth groups of cells comprises two or three cells.

6. The method as claimed in claim 1, further comprising:
after placing the fourth group of cylindrical cells, applying a layer of adhesive over the upper surface of the cylindrical cells in the fixture; and
placing one of a fifth group of cylindrical cells on top of each of the cells in the third group of cylindrical cells.

7. The method as claimed in claim 6, further comprising: after placing the fifth group of cylindrical cells, applying a layer of adhesive over the upper surface of the cylindrical cells in the fixture; and
placing one of a sixth group of cylindrical cells on top of each of the cells in the fourth group of cylindrical cells.

8. The method as claimed in claim 6, further comprising: after placing the fifth group of cylindrical cells, placing one of a sixth group of cylindrical cells on top of each of the cells in the fourth group of cylindrical cells.

9. A method of manufacture of a battery module comprising:
manufacturing first and second sets of mechanically connected cylindrical cells, wherein each sets of mechanically connected cylindrical cells is manufactured according to the method as claimed in claim 1;
connecting a respective busbar assembly to each of the first and second sets of mechanically connected cylindrical cells, wherein the busbar assemblies are located proximate the first ends of the cells in the respective set and are arranged to electrically connect the plurality of cells in each set in parallel, thereby to create first and second sub-assemblies;
positioning the first and second sub-assemblies within a housing; and
electrically connecting the busbar assemblies of the first and second sub-assemblies, such that the cells in the first sub-assembly are electrically connected to the cells in the second sub-assembly in series.

10. A method of manufacture of a vehicle, comprising manufacturing a battery module according to the method as claimed in claim 9, and further comprising installing the battery module within the vehicle.

11. A battery module manufactured according to the method of claim 1.

12. A vehicle comprising the battery module of claim 11.

13. A method of manufacture of a vehicle, comprising manufacturing a set of mechanically connected cylindrical cells according to the method as claimed in claim 1, and further comprising installing the set of mechanically connected cylindrical cells within the vehicle.
